(19) United States
(12) Patent Application Publication
(10) Pub. No.: US 2015/0371519 A1
(43) Pub. Date: Dec. 24, 2015

(54) Information Processing Device and Information Processing Method

(71) Applicant: Kabushiki Kaisha Toshiba, Tokyo (JP)

(72) Inventor: Junko Shimoharada, Hamura (JP)

(21) Appl. No.: 14/562,463

(22) Filed: Dec. 5, 2014

Related U.S. Application Data
(60) Provisional application No. 62/016,458, filed on Jun. 24, 2014.

(51) Int. Cl. G08B 21/02

(52) U.S. Cl. CPC G08B 21/02

(57) ABSTRACT

According to an embodiment, an information processing device includes, for example, a notification module, a first sensor, and a controller. The notification module is configured to inform a user of information. The first sensor is configured to detect that the user is traveling voluntarily. The controller is configured to switch, when the first sensor detects that the user is traveling voluntarily, a notification method by which the notification module informs the user of the information to a certain voluntary traveling notification method that differs from a notification method by which the notification module informs the user of the information when the user is not traveling voluntarily.

### CROSS-REFERENCE TO RELATED APPLICATIONS

This application claims the benefit of U.S. Provisional Patent Application No. 62/016,458, filed Jun. 24, 2014.

### FIELD

The embodiment disclosed herein generally relates to an information processing device and an information processing method.

### BACKGROUND

There are information processing devices, such as wearable devices, that are worn by a user on a part above the neck of the user such as glasses or an ear, and can inform the user of various types of information by, for example, displaying images or outputting sound.

A conventional information processing device informs a user who is wearing the information processing device of various types of information by the same method irrespective of the situation of the user. This causes the conventional information processing device to draw more attention of the user than necessary on informing the user of the various types of information when the user is traveling voluntarily. Consequently, surrounding information to which the user needs to pay attention is shut out, thereby making it difficult for the user to ensure safety.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram illustrating an example of a hardware configuration of a wearable device according to an embodiment;

FIG. 2 is a diagram illustrating an example of directions in which an acceleration sensor included in the wearable device according to the embodiment detects acceleration;

FIG. 3 is a flowchart illustrating an example of the procedure of switching processing for switching notification methods by which the wearable device according to the embodiment informs a user of notification information;

FIG. 4 is a diagram illustrating an example of the switching processing for switching the notification methods by which the wearable device according to the embodiment informs a user of notification information;

FIG. 5 is a flowchart illustrating an example of the procedure of the switching processing for switching the notification methods by which the wearable device according to the embodiment informs a user of notification information; and

FIG. 6 is a diagram illustrating an example of the switching processing for switching the notification methods by which the wearable device according to the embodiment informs a user of notification information.

### DETAILED DESCRIPTION

In general, according to an embodiment, an information processing device includes a notification module, a first sensor, and a controller. The notification module is configured to inform a user of information. The first sensor is configured to detect that the user is traveling voluntarily. The controller is configured to switch, when the first sensor detects that the user is traveling voluntarily, a notification method by which the notification module informs the user of the information to a certain voluntary traveling notification method that differs from a notification method by which the notification module informs the user of the information when the user is not traveling voluntarily.

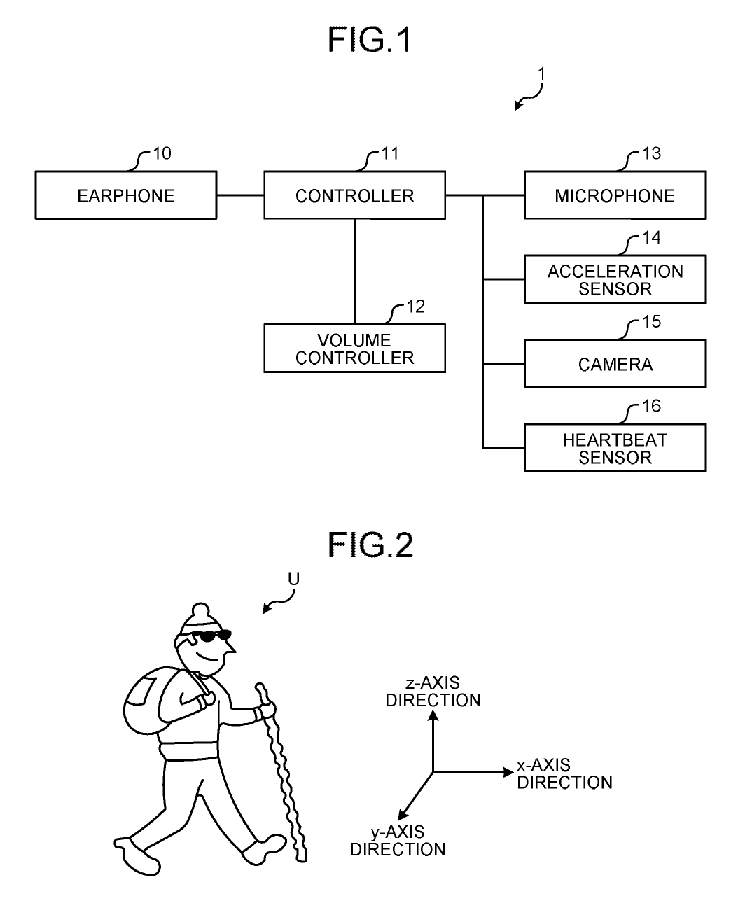

First, described is a hardware configuration of a wearable device 1 (an example of the information processing device) according to the present embodiment with reference to FIGS. 1 and 2. The wearable device 1 according to the present embodiment is a device that can be worn by a user on a part above the neck of the user and close to, for example, glasses or an ear. Specifically, as illustrated in FIG. 1, the wearable device 1 includes an earphone 10, a controller 11, a volume controller 12, a microphone 13, an acceleration sensor 14, a camera 15, and a heartbeat sensor 16.

The earphone 10 (an example of the notification module) informs a user U who is wearing the wearable device 1 of a first sound (such as music or a sound from a car navigation system) that is a sound of notification information (an example of the information). In the present embodiment, the earphone 10 has a noise cancelling function that cancels a second sound that is a sound of the surroundings of the user U.

Although, in the present embodiment, a case is described in which the earphone 10 is used as an example of the notification module that informs the user U who is wearing the wearable device 1 of notification information, the embodiment is not limited to this. Other types of modules can be used as the notification module such as a display module that is configured by, for example, a liquid crystal display (LCD) or an organic electro luminescence (EL) display and can display the notification information, a display module that can display the notification information in the air, or a display module that can display the notification information on a lens of a glasses-type (such as a goggles-type) wearable device.

The controller 11 controls each unit included in the wearable device 1. The volume controller 12 adjusts a volume of the first sound output from the earphone 10. The microphone 13 (an example of a sound collection module) is disposed such that it can collect the second sound of the surroundings of the user U.

The acceleration sensor 14 detects acceleration in three-axis directions (the x-axis direction, the y-axis direction, and the z-axis direction). As illustrated in FIG. 2, the x-axis direction is a direction (hereinafter referred to as a first direction) in which the user U who is wearing the wearable device 1 is facing. As illustrated in FIG. 2, the y-axis direction is perpendicular to the x-axis direction in the horizontal direction (that is, a direction of a horizontal vibration of the wearable device 1). As illustrated in FIG. 2, the z-axis direction is the direction of gravity (that is, a direction of a vertical vibration of the wearable device 1). The acceleration sensor 14 outputs the magnitude of the detected acceleration in the three-axis directions to the controller 11. The camera 15 (an example of an image-capturing module) is disposed such that it can capture the first direction in which the user U is facing. The heartbeat sensor 16 (an example of a third sensor) can detect the heartbeat of the user U who is wearing the wearable device 1.

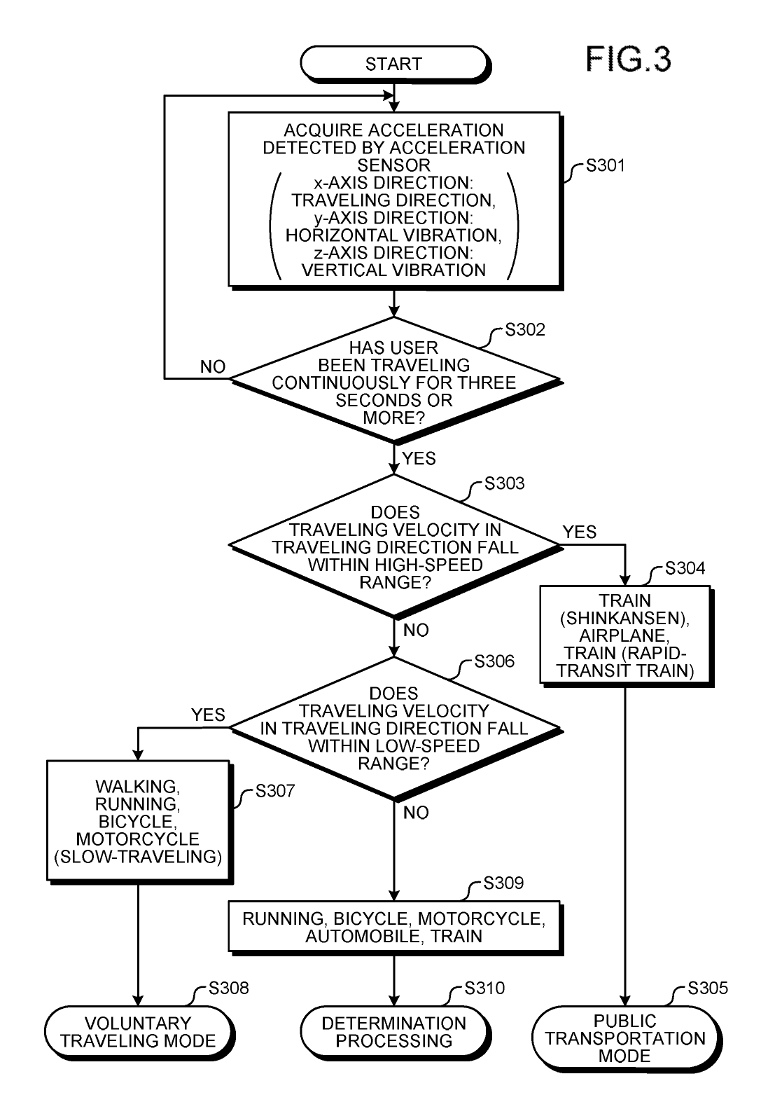

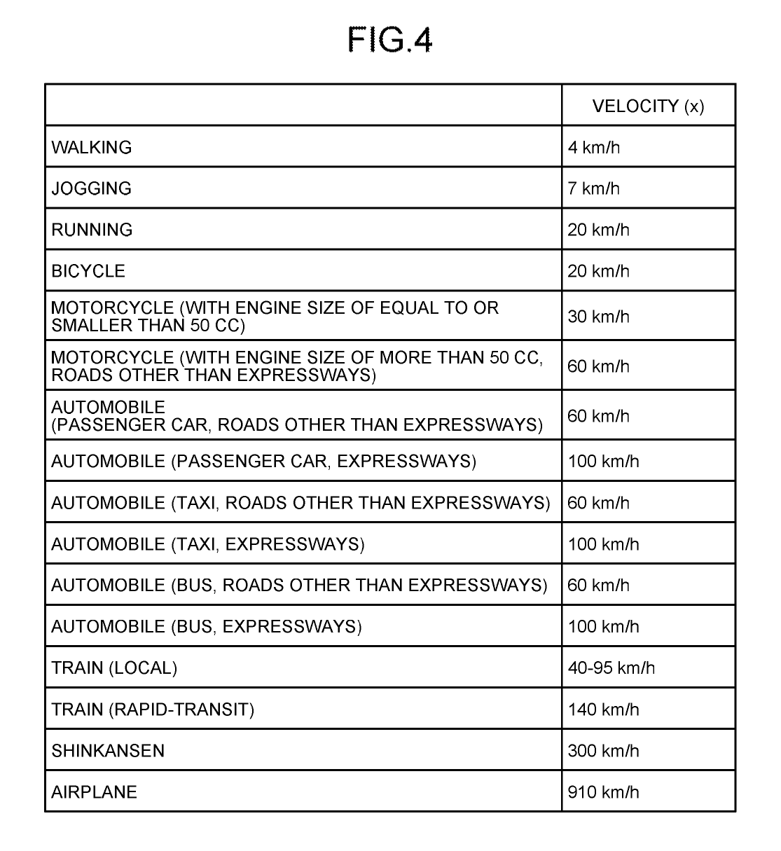

Described next is a notification process of the notification information relative to the user on the wearable device 1 according to the present embodiment with reference to FIGS. 3 and 4. When the wearable device 1 is turned on, the controller 11 starts acquiring acceleration in the three-axis directions (the x-axis direction, the y-axis direction, and the z-axis direction) detected by the acceleration sensor 14 (S301).

The controller 11 determines whether the user U has been traveling continuously for equal to or longer than a certain time period (three seconds in the present embodiment) on the basis of the acceleration in the three-axis directions acquired from the acceleration sensor 14 (S302). When the controller 11 determines that the user U has not been traveling continuously for equal to or longer than a certain time period (No at S302), the process returns to S301, and the controller 11 keeps acquiring the acceleration in the three-axis directions from the acceleration sensor 14.

On the other hand, when the controller 11 (an example of the first sensor) determines that the user U has been traveling continuously for equal to or longer than a certain time period (Yes at S302), the controller 11 detects (calculates) a traveling velocity in the direction in which the user U is traveling on the basis of the acceleration acquired from the acceleration sensor 14. In the present embodiment, the controller 11 uses a known method to detect a traveling velocity in the x-axis direction on the basis of the acceleration detected by the acceleration sensor 14.

The controller 11 detects whether the user U is traveling voluntarily on the basis of the detected traveling velocity. In the present embodiment, the controller 11 first determines whether the detected traveling velocity falls within a certain high-speed range (an example of a certain range of second velocity) (S303). The high-speed range is a range of velocity at which the user U cannot travel voluntarily. In the present embodiment, the controller 11 determines a train (rapid-transit train) velocity of 140 km/h, a Shinkansen velocity of 300 km/h, and an airplane velocity of 910 km/h illustrated in FIG. 4 to be the velocity at which the user U cannot travel voluntarily. Thus, a range of velocity equal to or higher than 130 km/h is defined as the high-speed range.

When the controller 11 determines that the detected traveling velocity falls within the high-speed range (Yes at S303), the controller 11 detects that the user U is using a means of traveling, such as a train (rapid-transit train), the Shinkansen, or an airplane, that the user U cannot operate in everyday life, that is, a means of traveling by which the user U cannot travel voluntarily (S304). The controller 11 switches a notification method by which the earphone 10 informs the user U of the notification information to a certain public transportation mode (S305).

The public transportation mode is a certain non-voluntary traveling notification method which informs the user U of the notification information irrespective of the situation of the surroundings of the user U. In the present embodiment, the noise cancelling function of the earphone 10 is turned on in the public transportation mode. This enables the user U to recognize the first sound of the notification information such as music or sound without being distracted by the situation of the surroundings (such as noise of the surroundings of the user U).

When the controller 11 determines that the detected traveling velocity does not fall within the high-speed range (No at S303), the controller 11 determines whether the detected traveling velocity falls within a low-speed range (an example of a range of first velocity) (S306). The low-speed range is a range of velocity slower than those in the high-speed range and at which the user U can travel voluntarily. In the present embodiment, the controller 11 determines a walking velocity of 4 km/h, a jogging velocity of 7 km/h, a running velocity of 20 km/h, a bicycle velocity of 20 km/h, and a velocity of a motorcycle (with an engine size of equal to or smaller than 50 cc) that travels slowly at 30 km/h illustrated in FIG. 4 to be the velocity at which the user U can travel voluntarily. Thus, a range of velocity equal to or lower than 30 km/h is defined as the low-speed range.

When the controller 11 determines that the detected traveling velocity falls within the low-speed range (Yes at S306), the controller 11 detects that the user U is traveling voluntarily (detects that, for example, the user U is traveling by walking, running, bicycle, or slow-traveling motorcycle) (S307). When the user U is traveling in a car, but when the detected traveling velocity falls within the low-speed range, it is highly possible that the user U is caught in a traffic jam. In this situation, the user U needs to pay attention to the surroundings of the user U. Thus, the controller 11 detects that the user U is traveling voluntarily. The controller 11 then switches a notification method by which the earphone 10 informs the user U of the notification information to a voluntary traveling mode (an example of a certain voluntary traveling notification method) that differs from the notification method (the public transportation mode in the present embodiment) of the notification information in the case where the user U is not traveling voluntarily (S308).

The voluntary traveling mode is a notification method which informs the user U of the situation of the surroundings of the user U (the second sound of the surroundings of the user U in the present embodiment). In the present embodiment, the voluntary traveling mode is a mode in which the earphone 10 outputs the second sound of the surroundings of the user U collected by the microphone 13 so that the user U can hear the second sound of the surroundings of the user U even when the user is wearing the earphone 10.

Although, in the present embodiment, the voluntary traveling mode is defined as a mode in which the earphone 10 outputs the second sound of the surroundings of the user U collected by the microphone 13, the voluntary traveling mode is not limited to this as long as informing the user U of the situation of the surroundings of the user U. For example, the voluntary traveling mode may be a mode in which the noise cancelling function of the earphone 10 is turned off and thereby informs the user U of the second sound of the surroundings of the user U even when the user U is wearing the earphone 10.

In another example, the voluntary traveling mode may be a mode in which the earphone 10 outputs a sound of notification information at a volume equal to or smaller than the volume of the second sound of the surroundings of the user U, so that the user U is informed of the second sound of the surroundings of the user U even when the user U is wearing the earphone 10. Alternatively, when the earphone 10 is outputting the first sound at a loud volume, the controller 11 switches to the voluntary traveling mode in which the controller 11 controls the volume controller 12 to reduce the volume of the first sound down to a volume at which the user U can hear the second sound of the surroundings of the user U. When the controller 11 switches to the voluntary traveling mode, for example, the controller 11 reduces the volume of the first sound output from the earphone 10 down to a volume equal to or smaller than a reference volume that is set to be higher by a certain volume than the volume of the second sound of the surroundings of the user U. The controller 11 may increase or reduce the volume of the first sound in accordance with an instruction from an operator through an operating unit (not illustrated) after switching to the voluntary traveling mode.

When the controller 11 determines that the detected traveling velocity does not fall within the low-speed range (No at S306), the controller 11 determines that the detected traveling velocity falls within a certain middle-speed range (an example of a certain range of third velocity) that is a range between the high-speed range and the low-speed range and at which the user U can travel voluntarily. When the controller 11 determines that the detected traveling velocity falls within the middle-speed range, the controller 11 determines that the user U is in a situation in which the controller 11 needs to determine whether the user U is traveling voluntarily (for example, in a situation in which the user U is traveling by running, bicycle, motorcycle, automobile, or train [local train]) (S309).

The middle-speed range is a range of velocity between the high-speed range and the low-speed range. In the present embodiment, the controller 11 determines a velocity of a motorcycle (with an engine size of more than 50 cc) of 60 km/h, a velocity of an automobile (such as a passenger car, taxi, or bus) traveling on roads other than expressways of 60 km/h, a velocity of an automobile (such as a passenger car, taxi, or bus) traveling on expressways of 100 km/h, and a velocity of a local train of 40 to 95 km/h illustrated in FIG. 4 to be the velocity at which the user U can travel voluntarily. Thus, a range of velocity from 60 to 130 km/h is defined as the middle-speed range.

When the controller 11 determines that the detected traveling velocity falls within the middle-speed range at which the user U can travel voluntarily, the controller 11 executes a determining process which determines whether the user U is traveling voluntarily (S310).

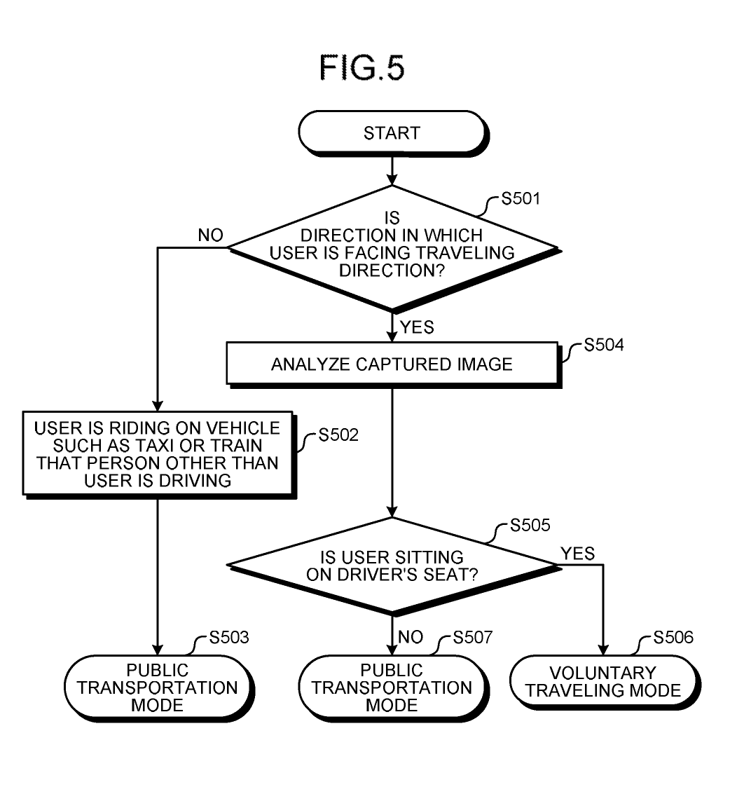

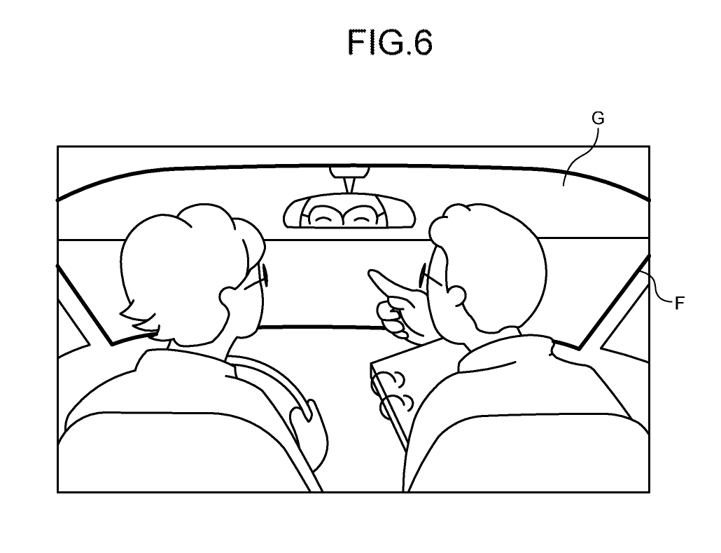

Described next is the determining process which determines whether the user is traveling voluntarily with reference to FIGS. 5 and 6. The controller 11 first determines whether the first direction in which the user U is facing matches the direction in which the user U is traveling on the basis of a detection result of the acceleration in the three-axis directions detected by the acceleration sensor 14 (S501). In the present embodiment, the controller 11 specifies the traveling direction of the user on the basis of the detection result of the acceleration in the three-axis directions detected by the acceleration sensor 14. The controller 11 then specifies an angle of the first direction (the x-axis direction) in which the user U is facing relative to the specified traveling direction of the user U in the horizontal direction on the basis of a detection result of the acceleration in the x-axis direction detected by the acceleration sensor 14. When the specified angle is equal to or smaller than a certain angle (20 degrees in the present embodiment), the controller 11 determines that the first direction in which the user U is facing matches the traveling direction of the user U.

When the controller 11 determines that the first direction in which the user U is facing does not match the traveling direction of the user U (No at S501), the controller 11 determines that the user U is riding on a vehicle (such as a taxi or a train) driven by a person other than the user U (which means the user U is not traveling voluntarily) (S502). The controller 11 then switches a notification method by which the earphone 10 informs the user U of the notification information to the public transportation mode (S503).

When the controller 11 determines that the direction in which the user U is facing matches the traveling direction of the user U (Yes at S501), the controller 11 analyses a captured image (an example of an image) captured by the camera 15 (S504), and determines whether the user U is sitting on the driver's seat of an automobile (an example of a vehicle) (S505). In the present embodiment, the controller 11 detects a frame F (see FIG. 6) of a windshield G (see FIG. 6) of the automobile from the captured image. The controller 11 specifies whether the user U is sitting on the right seat or the left seat on the basis of the detected shape of the frame F of the windshield G, so that determines whether the user U is sitting on the driver's seat of the automobile.

However, the driver's seat of an automobile is positioned on the right side or the left side of the automobile depending on a model of the automobile or a region in which the automobile is sold. Thus, the controller 11 determines whether the user U is sitting on the driver's seat of an automobile depending on whether the user is sitting on the right side or the left side of the automobile, and on the model of the automobile and the region in which the automobile is sold.

When the controller 11 determines that the user U is sitting on the driver's seat of an automobile on the basis of the captured image (Yes at S505), the controller 11 detects that the user is traveling voluntarily, and switches a notification method by which the earphone 10 informs the user U of the notification information to the voluntary traveling mode (S506). When the controller 11 determines that the user U is not sitting on the driver's seat (No at S505), the controller switches a notification method by which the earphone 10 informs the user U of notification information to the public transportation mode (S507).

The wearable device 1 according to the present embodiment determines whether the user U is in a situation in which the user U needs to pay most attention to safety depending on the environment in which the user U is using the wearable device 1 (depending on whether the user U is traveling voluntarily). When the wearable device 1 determines that the user U is in a situation in which the user U needs to pay most attention to safety, the user U does not need to switch, by hand, notification methods by which the wearable device 1 informs the user of the notification information, thereby improving the usability of the wearable device 1.

In the present embodiment, when a volume of a sound collected by the microphone 13 changes by equal to or larger than a certain volume within a certain unit time (in other words, when a volume of the sound of the surroundings of the user U largely changes), the controller 11 controls the volume controller 12 to, for example, reduce the volume of the sound output from the earphone 10, so that the earphone 10 stops informing the user U of the notification information. After a certain time has passed since the earphone 10 stopped informing the user U of the notification information, the controller 11 causes the earphone 10 to restart informing the user U of the notification information. With this configuration, when a sound of sudden braking or a car crash of an automobile occurs from the surroundings of the user U while the user U is driving an automobile, the wearable device 1 can stop informing the user U of the notification information from the earphone 10, thereby enabling the user U to easily recognize what has happened, such as an accident, in the surroundings of the user U.

In the present embodiment, the controller 11 (an example of a second sensor) detects vibration of the user U by using the acceleration detected by the acceleration sensor 14. When an amplitude of the detected vibration exceeds a certain amplitude, the controller 11 controls the volume controller 12 to, for example, reduce the volume of the sound output from the earphone 10, so that the earphone 10 stops informing the user U of the notification information. After a certain time has passed since the earphone 10 stopped informing the user U of the notification information, the controller 11 causes the earphone 10 to restart informing the user U of the notification information. With this configuration, if, for example, the automobile that the user U is driving accidentally comes in contact with a walker or a bicycle on a side of the automobile, the wearable device 1 can stop informing the user U of the notification information from the earphone 10, thereby enabling the user U to easily recognize what has happened in the surroundings of the user U such as the contact with a walker or a bicycle.

In the present embodiment, when the wearable device 1 includes the heartbeat sensor 16 that can detect the heartbeat of the user U, and when the heartbeat detected by the heartbeat sensor 16 exceeds a certain number of heartbeat, the controller 11 causes the earphone 10 to stop informing the user U of the notification information. After a certain time has passed since the earphone 10 stopped informing the user U of the notification information, the controller 11 causes the earphone 10 to restart informing the user U of the notification information. With this configuration, when a large-sized vehicle comes close to the automobile that the user U is driving and the heartbeat of the user U increases accordingly, the wearable device 1 can stop informing the user U of the notification information, thereby enabling the user U to easily pay attention to the surroundings of the user U when the user U feels tense.

In the present embodiment, when a display module that can display the notification information is used as the notification module that informs the user U of the notification information, the controller 11 may switch to the voluntary traveling mode which informs the user U of the situation of the surroundings of the user U by not allowing the display module to display the notification information, or by causing the display module to display information relevant to the situation of the surroundings of the user U (for example, causing the display module to display the information relevant to the surroundings of the user U overlaying the display of the notification information).

Moreover, the various modules of the systems described herein can be implemented as software applications, hardware and/or software modules, or components on one or more computers, such as servers. While the various modules are illustrated separately, they may share some or all of the same underlying logic or code.

While a certain embodiment has been described, the embodiment has been presented by way of example only, and is not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the invention.

What is claimed is:

1. An information processing device comprising:
a notification module configured to inform a user of information;
a first sensor configured to detect that the user is traveling voluntarily; and
a controller configured to switch, when the first sensor detects that the user is traveling voluntarily, a notification method by which the notification module informs the user of the information to a certain voluntary traveling notification method that differs from a notification method by which the notification module informs the user of the information when the user is not traveling voluntarily.

2. The information processing device of claim 1, wherein the first sensor detects a traveling velocity of the user, and detects that the user is traveling voluntarily when the detected traveling velocity falls within a certain range of first velocity at which the user is capable of traveling voluntarily.

3. The information processing device of claim 2, further comprising:
an image-capturing module configured to capture a first direction in which the user is facing, wherein
when the detected traveling velocity of the user falls within a certain range of third velocity between the range of first velocity and a certain range of second velocity at which the user is not capable of traveling voluntarily, when the first direction matches a direction in which the user is traveling, and when the first sensor determines that the user is sitting on a driver's seat of a vehicle based on an image captured by the image-capturing module, the first sensor detects that the user is traveling voluntarily.

4. The information processing device of claim 1, wherein
the notification module informs the user of a first sound that is a sound of the information; and
the voluntary traveling notification method is a method for informing the user of a second sound that is a sound of surroundings of the user.

5. The information processing device of claim 4, wherein
the notification module has a noise cancelling function that cancels the second sound; and
the voluntary traveling notification method is a method for informing the user of the second sound by turning off the noise cancelling function.

6. The information processing device of claim 4, wherein the voluntary traveling notification method is a method for informing the user of the second sound by reducing a volume of the first sound down to a volume equal to or smaller than a volume of the second sound.

7. The information processing device of claim 1, further comprising:
a sound collection module configured to collect a sound of surroundings of the user, wherein
when a volume of the sound collected by the sound collection module changes by equal to or larger than a certain volume within a certain unit time, the controller causes the notification module to stop informing the user of the information, and causes the notification module to restart informing the user of the information after a certain time has passed since the controller caused the notification module to stop informing the user of the information.

8. The information processing device of claim 1, further comprising:
a second sensor configured to detect vibration of the user, wherein
when an amplitude of the vibration detected by the second sensor exceeds a certain amplitude, the controller causes the notification module to stop informing the user of the information, and causes the notification module to restart informing the user of the information after a certain time has passed since the controller caused the notification module to stop informing the user of the information.

9. The information processing device of claim 1, further comprising:
a third sensor configured to detect a heartbeat of the user, wherein
when the heartbeat detected by the third sensor exceeds a certain number of heartbeat, the controller causes the notification module to stop informing the user of the information, and causes the notification module to restart informing the user of the information after a certain time has passed since the controller caused the notification module to stop informing the user of the information.

10. An information processing method comprising:
informing a user of information;
detecting that the user is traveling voluntarily; and
switching, when the user is detected traveling voluntarily, a notification method for informing the user of the information to a certain voluntary traveling notification method that differs from a notification method for informing the user of the information when the user is not traveling voluntarily.

11. The information processing method of claim 10, further comprising:
detecting a traveling velocity of the user, wherein
when the detected traveling velocity falls within a certain range of first velocity at which the user is capable of traveling voluntarily, the user is detected traveling voluntarily.

12. The information processing method of claim 11, further comprising:
capturing a first direction in which the user is facing, wherein
when the detected traveling velocity of the user falls within a certain range of third velocity between the range of first velocity and a certain range of second velocity at which the user is not capable of traveling voluntarily, when the first direction matches a direction in which the user is traveling, and when the user is determined to be sitting on a driver's seat of a vehicle based on an image obtained by capturing the first direction, the user is detected traveling voluntarily.

13. The information processing method of claim 10, wherein
the user is informed of a first sound that is a sound of the information, and
the voluntary traveling notification method is a method for informing the user of a second sound that is a sound of surroundings of the user.

14. The information processing method of claim 13, wherein the voluntary traveling notification method is a method for informing the user of the second sound by turning off a noise canceling function that cancels the second sound.

15. The information processing method of claim 13, wherein the voluntary traveling notification method is a method for informing the user of the second sound by reducing a volume of the first sound down to a volume equal to or smaller than a volume of the second sound.

16. The information processing method of claim 10, further comprising:
collecting a sound of surroundings of the user;
stopping informing the user of the information when a volume of the collected sound changes by equal to or larger than a certain volume within a certain unit time; and
restarting informing the user of the information after a certain time has passed since the stopping of informing the user of the information.

17. The information processing method of claim 10, further comprising:
detecting vibration of the user;
stopping informing the user of the information when an amplitude of the detected vibration exceeds a certain amplitude; and
restarting informing the user of the information after a certain time has passed since the stopping of informing the user of the information.

18. The information processing method of claim 10, further comprising:
detecting a heartbeat of the user;
stopping informing the user of the information when the detected heartbeat exceeds a certain number of heartbeat; and
restarting informing the user of the information after a certain time has passed since the stopping of informing the user of the information.
